(19) United States
(12) Patent Application Publication
(10) Pub. No.: US 2010/0096846 A1
(43) Pub. Date: Apr. 22, 2010

(54) OBJECTS THAT INCLUDE SOIL FROM PREDETERMINED PLACES

(76) Inventor: Yaakov Naimi, Beverly Hills, CA (US)

Correspondence Address: ADELI & TOLLEN, LLP, 11940 San Vicente Blvd., Suite 100, LOS ANGELES, CA, 90049, US

(21) Appl. No.: 12/604,387

(22) Filed: Oct. 22, 2009

Related U.S. Application Data
(60) Provisional application No. 61/107,659, filed on Oct. 22, 2008.
(60) Provisional application No. 61/107,657, filed on Oct. 22, 2008.

(51) Int. Cl. B42D 3/12; B23P 11/00

(52) U.S. Cl. 281/29; 29/428

(57) ABSTRACT

Some embodiments provide a method for making a book. The method receives soil from a predetermined location. The method specifies a compartment on the book for storing the soil. The method places the soil in the compartment. The method covers the compartment to secure the soil. Some embodiments include a compartment cover for sealing the soil inside the compartment. In some embodiments the compartment cover is made of a transparent material. In some embodiments the compartment cover is glued to the book cover.

### CLAIM OF BENEFIT TO RELATED APPLICATION

This application claims the benefit of U.S. Provisional Application 61/107,659, entitled “Book that Includes Soil from Predetermined Places”, filed Oct. 22, 2008; and U.S. Provisional Application 61/107,657, entitled “Objects that Include Soil from Predetermined Places”, filed Oct. 22, 2008. The contents of U.S. Provisional Application 61/107,659 and U.S. Provisional Application 61/107,657 are hereby incorporated by reference.

### FIELD OF THE INVENTION

The present invention is directed to objects such as books that are configured for holding soil from predetermined places and method of making thereof.

### BACKGROUND OF THE INVENTION

Many people consider earth, soil, dirt, or stone from certain places on earth as holy or otherwise important. Many people wish to say prayer on this holy or otherwise important soil. Many people say prayer while holding an object. Many people like to keep objects or utilize objects that have spiritual, religious, or otherwise sensational value for them. Therefore, there is a need in the art to provide a method for making and/or selling objects that are configured to include soil from predetermined places.

### SUMMARY OF THE INVENTION

Some embodiments provide a method for making objects that include soil from predetermined places. The method receives soil from at least one predetermined location. The method makes a compartment in the object for storing the soil. The method places the soil in the compartment. The method covers the compartment to secure the soil.

Some embodiments provide a method for making a book. The method receives soil from at least one predetermined location. The method makes a compartment on the cover of the book for storing the soil. The method places the soil in the compartment. The method covers the compartment to secure the soil.

Some embodiments provide objects such as books, goblets, candleholder, jewelry, boxes, and bookmarks that are configured for holding soil from predetermined places. In some embodiments, the soil in placed in a sealed compartment. In some embodiments, the compartment has a transparent cover through which the soil can be visible.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates a process for making an object in some embodiments.

FIG. 2 illustrates an object with a compartment for holding soil in some embodiments.

FIG. 3 illustrates the object of FIG. 2 after soil is placed in the soil compartment in some embodiments.

FIG. 4 illustrates a cover for securing the soil in the soil compartment of FIG. 3.

FIG. 5 illustrates a container for holing soil in some embodiments.

FIG. 6 illustrates an object with a compartment for receiving a soil container in some embodiments.

FIG. 7 illustrates a soil container being placed in the soil compartment in some embodiments.

FIG. 8 illustrate the soil container of FIG. 5 being secured to a side of an object in some embodiments.

FIG. 9 conceptually illustrates a process for making a book in some embodiments.

FIG. 10 illustrates a book made according to some embodiments of the invention.

FIG. 11 illustrates a book with a recess for placing the covering of the soil compartment according to some embodiments of the invention.

FIG. 12 illustrates a book made according to some embodiments of the invention.

FIG. 13 illustrates a goblet made according to some embodiments of the invention.

FIG. 14 illustrates a candleholder made according to some embodiments of the invention.

FIGS. 15 and 16 illustrate a piece of jewelry made according to some embodiments of the invention.

FIGS. 17 and 18 illustrate a box made according to some embodiments of the invention.

FIG. 19 illustrates a bookmark made according to some embodiments of the invention.

FIG. 20 illustrates a crucifix made according to some embodiments of the invention.

### DETAILED DESCRIPTION OF THE INVENTION

In the following description, numerous details are set forth for purpose of explanation. However, one of ordinary skill in the art will realize that the invention may be practiced without the use of these specific details. In other instances, well-known structures and devices are shown in block diagram form in order not to obscure the description of the invention with unnecessary detail.

Some embodiments provide a method for making objects that include soil from predetermined places. The method receives soil from at least one predetermined location. The method makes a compartment in the object for storing the soil. The method places the soil in the compartment. The method covers the compartment to secure the soil.

Some embodiments provide a method for making a book. The method receives soil from at least one predetermined location. The method makes a compartment on the cover of the book for storing the soil. The method places the soil in the compartment. The method covers the compartment to secure the soil.

Some embodiments provide objects such as books, goblets, candleholder, jewelry, boxes, and bookmarks that are configured for holding soil from predetermined places. In some embodiments, the soil in placed in a sealed compartment. In some embodiments, the compartment has a transparent cover through which the soil can be visible.

Several more detailed embodiments of the invention are described in sections below. Section I describes methods of making or configuring objects for holding soil from predetermined locations. Next, Section II describes a more detailed method of making or configuring a book for holding soil from predetermined locations. Finally, Section III presents examples of several objects that are configured according to different embodiments of the invention for holding soil from predetermined location.

I. Methods of Making or Configuring Objects for Holding Soil from Predetermined Locations

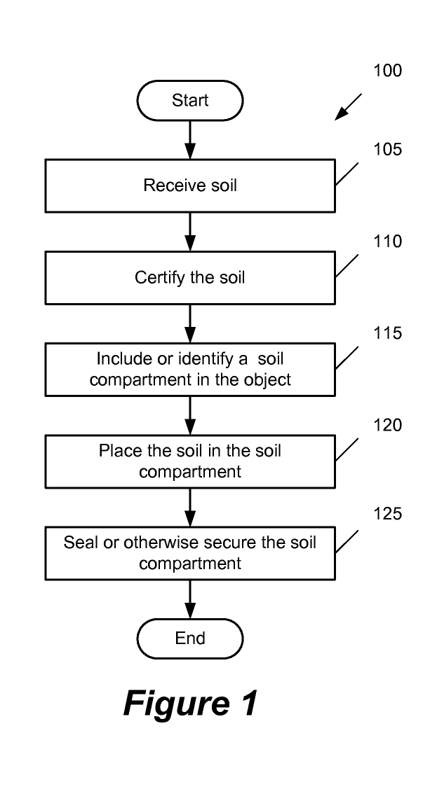

FIG. 1 conceptually illustrates a process 100 for making an object in some embodiments. The specific operations of the process may not be performed in the exact order described. The specific operations may not be performed in or as one continuous series of operations. Different specific operations may be performed in different embodiments. Furthermore, the process could be implemented using several sub-processes, or as part of a larger macro-process. Also, parts of the process such as making a compartment, a container, sealing, attaching, fastening, nailing, screwing, casting, molding, etc. can be performed automatically by a machine.

Several objects such as a piece of jewelry, a cup, a candle holder, and a box are described as examples of different objects that can be made by practicing the disclosed invention. In some embodiments, the object includes several pieces and the soil can be placed on one or more of the pieces that comprises the object. For instance, the object can be a jewelry box that includes a separate cover and the soil is placed in one or more compartments included in the cover and/or in one or more compartments included in the box. As way of example, different objects are described as having different materials such as glass, wood, and/or metal. A person of ordinary skill in the art, however, would realize that the same methods, processes, and techniques disclosed herein can be utilized to include soil from predetermined places in other objects made of different materials.

As shown, the process receives (at 105) soil from one or more predetermined places. In some embodiments, the place where the soil is received is a religious place, holy place, or a historic place. The word soil hereinafter is used to cover earth, dirt, soil, dust, pebble, stones, rocks, etc. or a combination thereof. In some embodiments, the soil is pressed to make the soil grains, dust, rock, and/or pebble stick together. In some embodiments, the soil is heated or otherwise sanitized to remove any germs and harmful organisms.

Optionally, some embodiments certify (at 110) the authenticity of the soil. For instance, in some embodiments taking the soil from each of the places is witnessed. In some embodiments, the person who takes the soil writes a statement (or a declaration) about the authenticity of the soil, signs the statement, and/or notarizes the signature by a different person. In some embodiments, the soil is taken by a well known person such as a clergyman, priest or rabbi who declares or swears to the origin of the soil as being taken from a designated place. In some embodiments, the soil is taken from one or more places such as Jerusalem, Bethlehem, Jericho, Nazareth, Galilee, Mecca, Karbala, Red Sea, or any other religious or historical place. In some embodiments, the soil is taken from one or more specific synagogues, churches, temples, mosques, memorial places, etc.

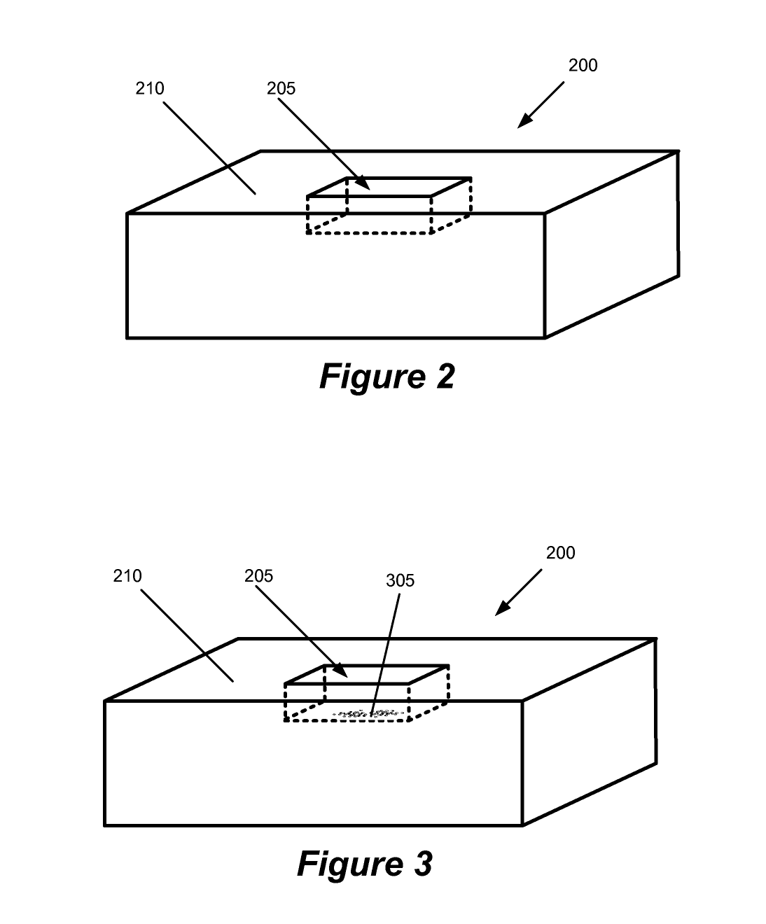

Next, the process prepares or identifies (at 115) one or more soil compartments for storing the soil in or on the object. In some embodiments, the soil compartment is made during the manufacturing of the object. In other embodiments, the compartment is made after the object is manufactured. In some embodiments, the compartment is part of an existing cavity inside the object. FIG. 2 illustrates an object 200 with a compartment 205 for holding soil in some embodiments. As shown, the compartment is made (or is an existing cavity) accessible from a side 210 of the object 200.

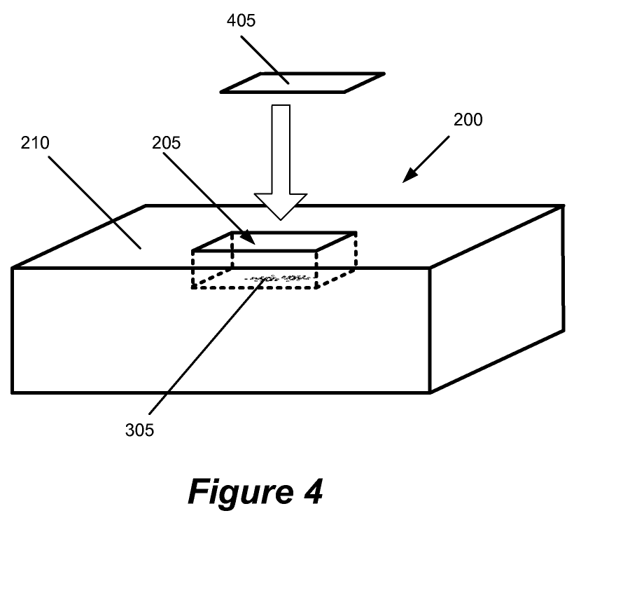

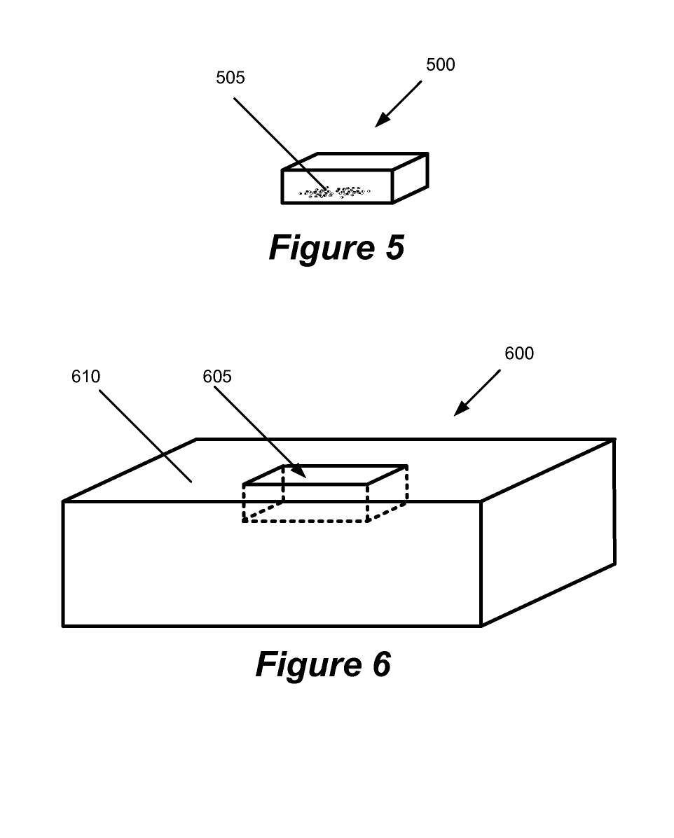

Next, process 100 places (at 120) the soil in the soil compartment. In some embodiments, placing the soil in the compartment is also certified and/or witnessed in a similar fashion as described above for certifying the soil. FIG. 3 illustrates object 200 of FIG. 2 after soil 305 is placed in soil compartment 205 according to some embodiments. Next the process seals (or otherwise secures) (at 125) the soil in the soil compartment by sealing the soil compartment. FIG. 4 illustrates a cover 405 for securing the soil 305 in the soil compartment 205 of FIG. 3 according to some embodiments. Different embodiments secure the cover to the compartment in different way. Depending on the shapes, materials, and dimensions of the cover 405 and the object 200, the cover can be glued, nailed, screwed, sewn, or fastened to the object in order to seal the soil compartment. In some embodiments, the soil compartment has a groove (not shown) to facilitate placing the cover on the top of the compartment. Several different examples of making a compartment and sealing it for different objects are described further below. In some embodiments the soil compartment is permanently sealed after the soil is placed in the soil compartment.

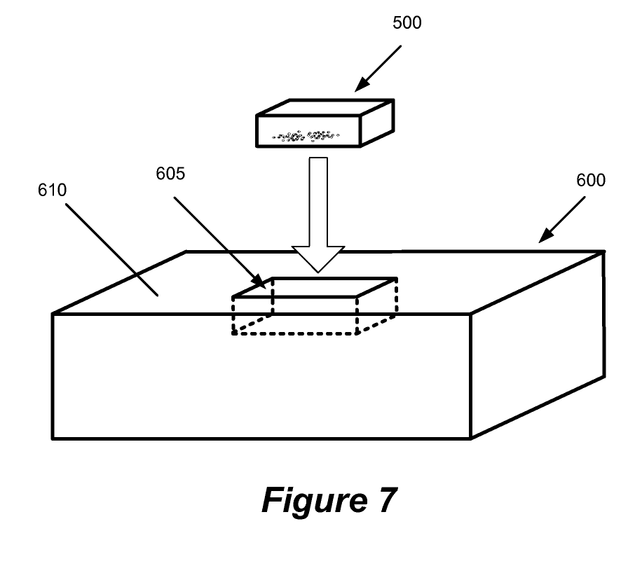

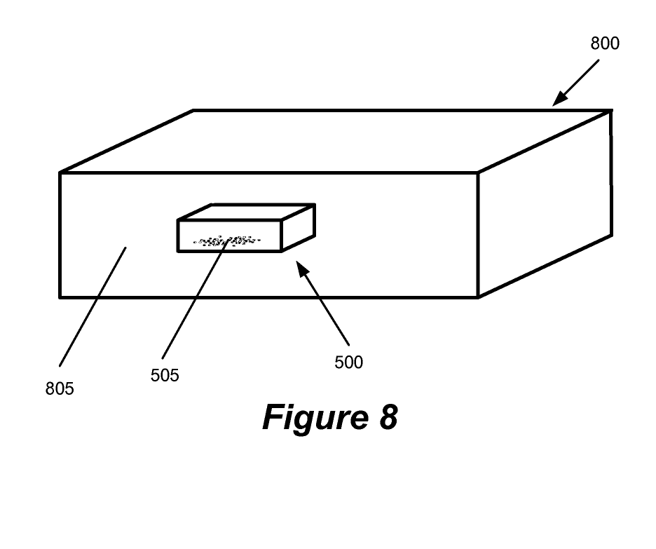

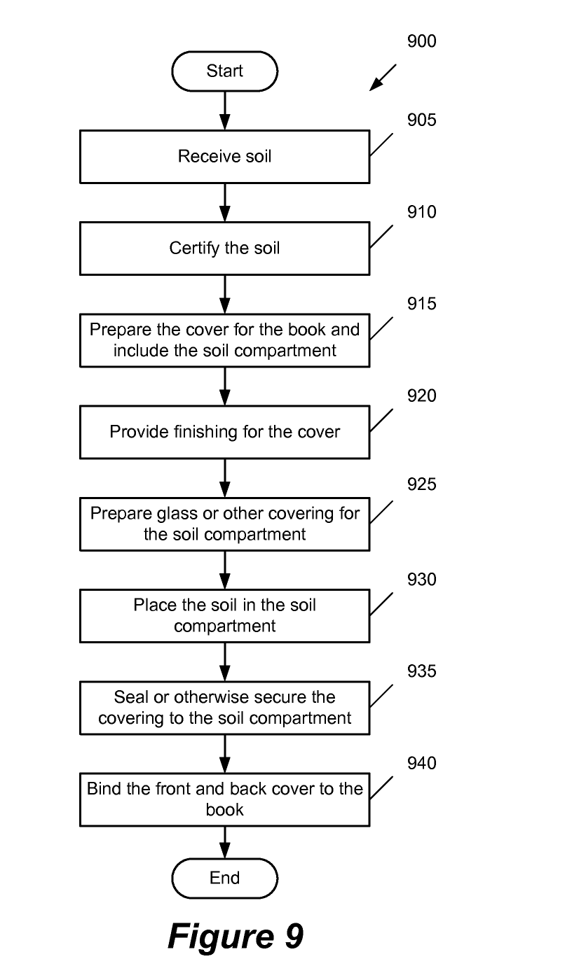

Some embodiments include the soil in a separate container (e.g., a pouch, package, bag, pocket, etc.) and then secure this container to the object. FIG. 5 illustrates a container 500 for holing soil 505 in some embodiments. In some embodiments, the object includes a compartment (e.g., a recess or a cavity) for receiving the soil container. FIG. 6 illustrates an object 600 with a compartment 605 for receiving the soil container 500. As shown, the compartment is accessible through a side 610 of the object. In some embodiments compartment 605 is made in the object at manufacturing time. In these embodiments, process 100 identifies (at 115) this compartment for receiving the soil container. In other embodiments, process 100 makes (at 115) the compartment, e.g., by carving or cutting a cavity on the object. In some embodiments, process 100 places (at 120) the soil container 500 in the compartment 605. FIG. 7 illustrates the soil container 500 being placed in soil compartment 605 of object 600.

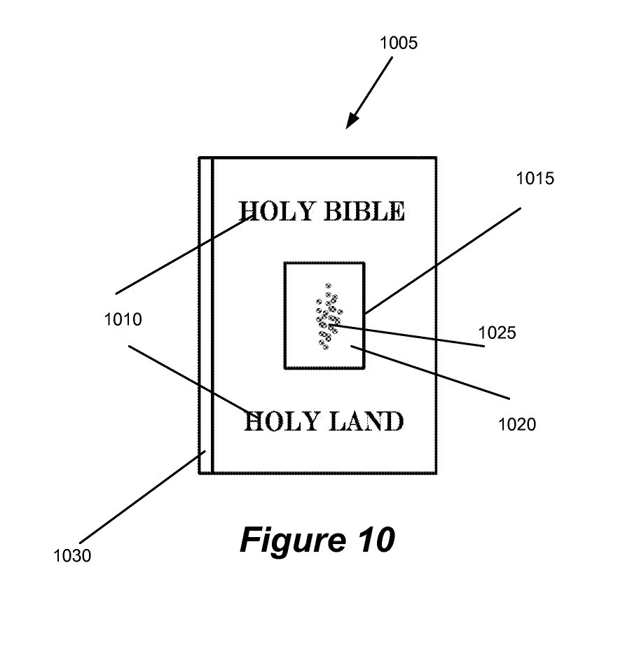

Some embodiments, secure the container to the object without placing the soil container in a recess or compartment. FIG. 8 illustrates the soil container 500 being securely attached to a side 805 of an object 800. Depending on the shapes, materials, and dimensions of the container 500 and the object 800, the container can be glued, nailed, screwed, sewn, or fastened to the object in order to secure the soil container 500 to the object 800. In other embodiments, the container is attached to a string and the string is secured to the object (e.g., to a book) by gluing. In some embodiments the string is secured to the book by threading the string through the binding, the body, or the cover of the book.

The container can be made of wood, metal, plastic, glass, crystal, cloth, leather, or any other material adequate for holding the soil. In some embodiments, the container is made of multiple materials. For instance, the container can be made of one or more opaque materials (e.g., wood, metal, leather, opaque plastic, opaque glass, cloth, etc.) and/or one or more transparent materials (e.g., transparent glass, transparent plastic, crystal, etc.) to facilitate securing the container to the book as well as providing visibility of the soil to a user. In some embodiments, the soil is placed in the container and the container is sealed prior to attaching the container to the object.

Although the object and compartment of FIGS. 5-8 are shown as rectangular objects, a person of ordinary skill in the art would realize that the object and compartment can have other shapes and forms without deviating from the teachings of the invention.

A more detailed process, according to some embodiments of the invention, for configuring and/or making a book for holding soil from predetermined places is described in the following section. The same process can be applied to configure other objects (e.g., a box, a crucifix, etc.) for holding soil from predetermined places.

II. Method of Making or Configuring a Book for Holding Soil from Predetermined Locations

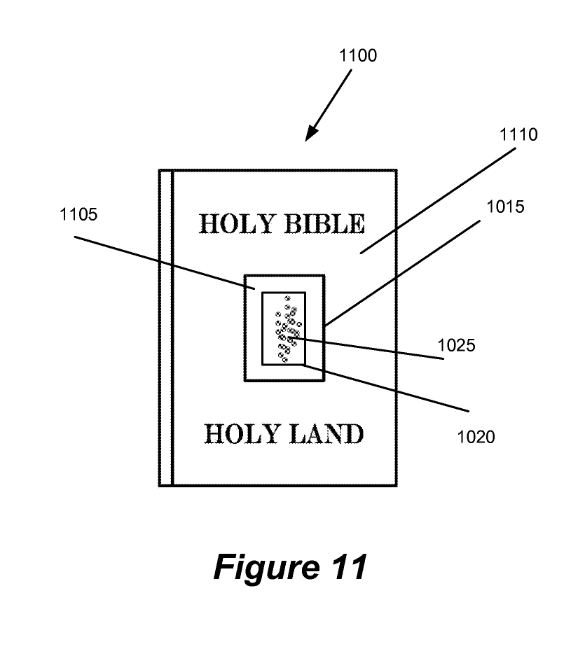

FIG. 9 conceptually illustrates a process 900 for making and/or configuring a book in some embodiments. The operations of process 900 can be performed in addition or in place of operations described for process 100, above. The specific operations of the process may not be performed in the exact order described. The specific operations may not be performed in or as one continuous series of operations. Different specific operations may be performed in different embodiments. Furthermore, the process could be implemented using several sub-processes, or as part of a larger macro-process. Also, parts of the process such as making a compartment, a container, sealing, attaching, fastening, nailing, screwing, casting, molding, etc. can be performed automatically by a machine.

As shown, the process receives (at 905) soil from one or more predetermined places. In some embodiments, the place where the soil is received is a religious place, holy place, or a historic place. The word soil is used to cover earth, dirt, soil, dust, pebble, stones, rocks, etc. or a combination thereof. In some embodiments, the soil is pressed to make the soil grains, dust, rock, and/or pebble stick together. In some embodiments, the soil is pressed to make the soil grains, dust, rock, and/or pebble stick together. In some embodiments, the soil is heated or otherwise sanitized to remove any germs and harmful organisms.

Optionally, some embodiments certify (at 910) the authenticity of the soil. For instance, in some embodiments taking the soil from each of the places is witnessed. In some embodiments, the person who takes the soil writes a statement (or a declaration) about the authenticity of the soil, signs the statement, and/or notarizes the signature by a different person. In some embodiments, the soil is taken by a well known person such as a clergyman, priest or rabbi who declares or swears to the origin of the soil as being taken from a designated place. In some embodiments, the soil is taken from one or more places such as Jerusalem, Bethlehem, Jericho, Nazareth, Galilee, Mecca, Karbala, Red Sea, or any other religious or historical place. In some embodiments, the soil is taken from one or more specific synagogues, churches, temples, mosques, memorial places, etc.

Next, the process prepares or identifies (at 915) one or more soil compartments on the book (e.g., on the outside or outside of the cover, on the inside or outside of the binding, or anywhere else on the book). Some embodiments include soil in a container (e.g., a pouch, package, bag, pocket, etc.) and attach the container to the book as described further below. In some embodiments, the book is manufactured or has already been modified to include one or more compartments. In these embodiments, the process identifies one or more of these compartments for holding the soil.

In some embodiments, the book does not include a compartment and the process prepares one or more compartments anywhere inside or outside of the book (e.g., on the inside or outside cover, on the inside or outside of the binding, etc.). In these embodiments, the process first identifies the location for one or more compartments. The process then prepares one or more compartments for holding the soil. An example of making a compartment on the cover is described herein. The example describes how a cover is made for storing the soil. However, one of ordinary skill in the art would realize that the same method can be used to make a compartment (e.g., by carving the compartment) on an existing cover, to make a book to include a compartment anywhere else inside or outside the book, or to make a compartment anywhere inside an existing book.

In the example of making a book cover for storing the soil, the measurements for the book cover are made. The cover is then made from a material such as wood, leather, plastic, metal, pressboard, or any other material for a book cover known in the art. For instance, in some embodiments a carpenter hand carves the cover. In some embodiments the title and other writings on the covers are also carved on the cover. The carpenter also carves a compartment for holding the dirt on the cover.

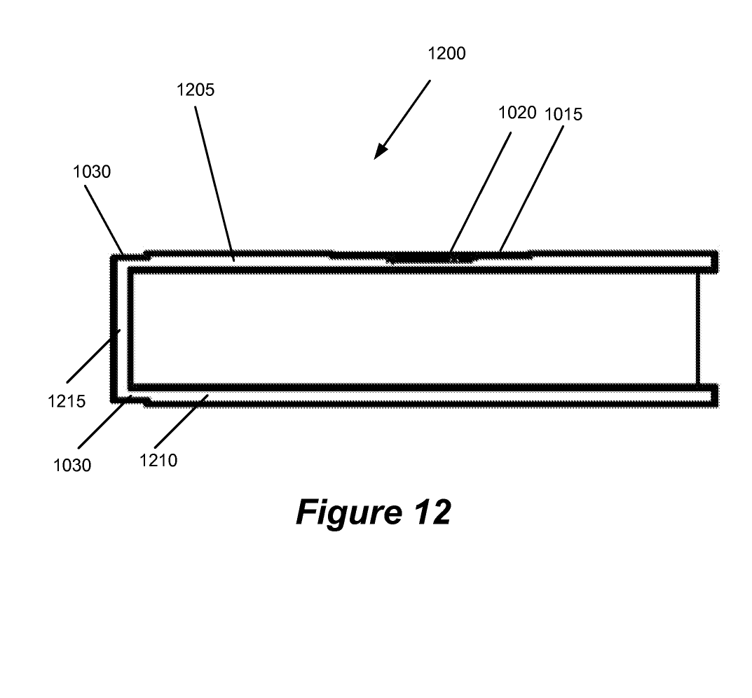

Different embodiments have the compartment on different places on the cover. For instance, the compartment can have different size and shapes (e.g., rectangular, circular, oval, triangular, irregular shape, etc.) and can be placed on one or more places on the front, back, inside front, and/or inside back cover. FIG. 10 illustrates a cover 1005 with a soil compartment 1020 in some embodiments.

Although a wood cover was described as an example, the cover can be made from other material such as metal, plastic, cardboard, pressboard, leather, or any other known book cover material without deviating from the spirit of the invention.

Some embodiments include the soil in a separate container (e.g., a pouch, package, bag, pocket, etc.). Different embodiments secure this soil container to the book differently. For instance, depending on the materials, shapes, and dimensions of the book and the container, some embodiments glue, nail, or screw the container to the book. In other embodiments, the container is attached to a string and the string is secured to the book by gluing. In some embodiments the string is secured to the book by threading the string through the binding, the body, or the cover of the book. The container can be made of wood, metal, plastic, glass, cloth, leather, or any other material adequate for holding the soil. In some embodiments, the container is made of multiple materials. For instance, the container can be made of one or more opaque materials (e.g., wood, metal, leather, opaque plastic, opaque glass, cloth, etc.) and/or one or more transparent materials (e.g., transparent glass, transparent plastic, crystal, etc.)

to facilitate securing the container to the book as well as providing visibility of the soil to a user.

Next, some embodiments optionally provide (at 920) finishing for the cover. In some embodiments, the finishing is a precious metal such as gold, platinum, or silver. In some embodiments, the finishing is cloth, leather, plastic, vinyl, printed paper, dyed paper, or similar material. In some embodiments, the cover can be pained. In some embodiments, the cover is decorated with wood carving or embossing. In some embodiments the title and other writings on the book can be carved on the wood, etched on the metal, printed on the paper or cloth. As shown in FIG. 10, writings 1010 are optionally carved (or etched or written) on the cover 1005 in some embodiments.

Next, the process prepares (at 925) a cover (or cap, top, lid) 1015 for the soil compartment 1020. In some embodiments this cover is made of glass. For instance, some embodiments provide a beveled glass to cover the soil compartment. In some embodiments, the cover can be transparent or non-transparent plastic. Yet in other embodiments the cover can be made of wood, metal, crystal, or other material suited for covering the compartment.

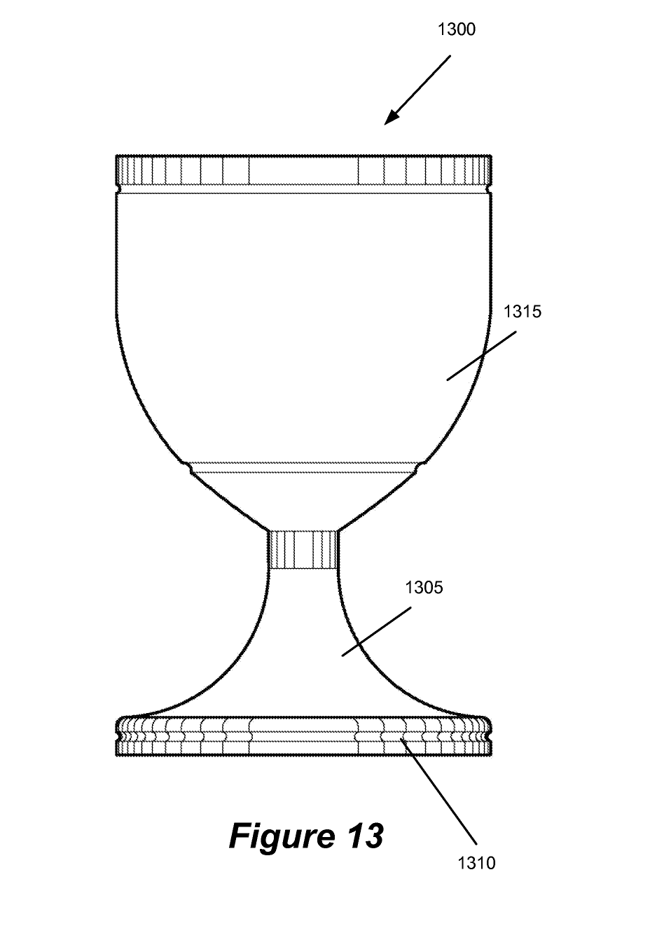

Next, the process places (at 930) the soil 1025 in the soil compartment 1020. In some embodiments, placing the soil in the compartment is certified and/or witnessed in a similar fashion as described above for certifying the soil. Next, the process secures (at 935) the covering of the soil compartment. In some embodiments, the covering is glued (e.g., by using a clear glue) to the soil compartment. In some embodiments, the compartment covering (depending on the covering material) is hinged, screwed, or otherwise secured by similar methods to the soil compartment. In some embodiments, a recess is made around the soil compartment in order to facilitate securing the cover on the soil compartment. FIG. 11 illustrates a book cover 1100 in some embodiments. As shown, a recess 1105 is made around the soil compartment 1020. For instance, the recess can be one eight of an inch lower than surface 1110 of the book cover 1100 while the soil compartment 1020 can be half an inch deep. The compartment cover 1015 is then placed over the recess. In the embodiments that the cover, 1015 is made of glass, the cover can be glued to the top of the recess to secure the cover. In some embodiments the soil compartment is permanently sealed after the soil is placed in the soil compartment.

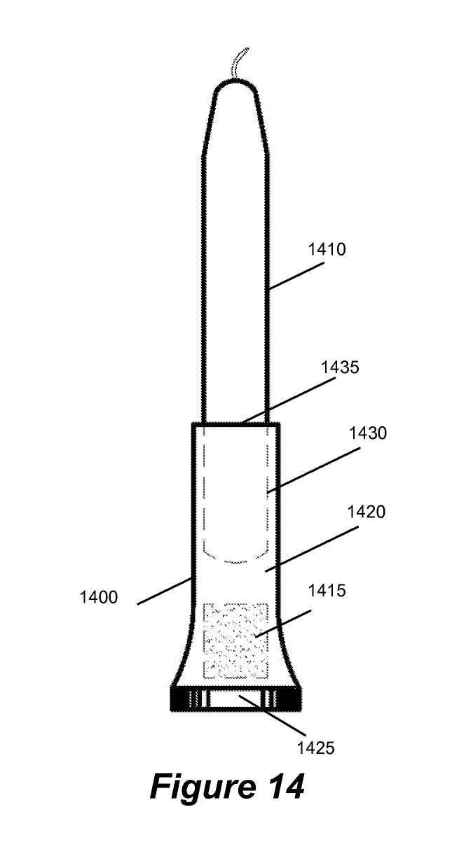

Next, the process binds (at 940) the front and back covers and the book together. FIG. 12 illustrates a book 1200 in some embodiments. In some embodiments, the front 1205 and the back 1210 covers are first bound together. For instance, some embodiments bind the front 1205 and back cover 1210 by gluing a stripe of leather (or cloth) 1215 to the front and back covers. As shown in FIGS. 10 and 12, some embodiments include a recess 1030 on the side of each cover. The leather (or cloth) 1215 can be glued or otherwise fastened to this recess 1030. Other embodiments use other binding methods known in the art to bind the front and back covers together. The process then binds the book to the covers by using glue, thread, staples, screws, or any other technique known in the art for binding a book to its covers.

In some embodiments, the book used in this process is especially printed for the purpose of placing the soil on it. In other embodiments, the book is any off-the-shelf printed or hand-written book acquired for the purpose of placing the soil on the book. In some embodiment, the book is Torah, Bible, Koran, or other religious, spiritual, or historical books.

A book made or configured for holding soil from predetermined places was described in this section. Examples of several more objects that are made or configured for holding soil in accordance to difference embodiments of the invention are described in the following section.

III. Examples of Objects for Holding Soil from Predetermined Locations

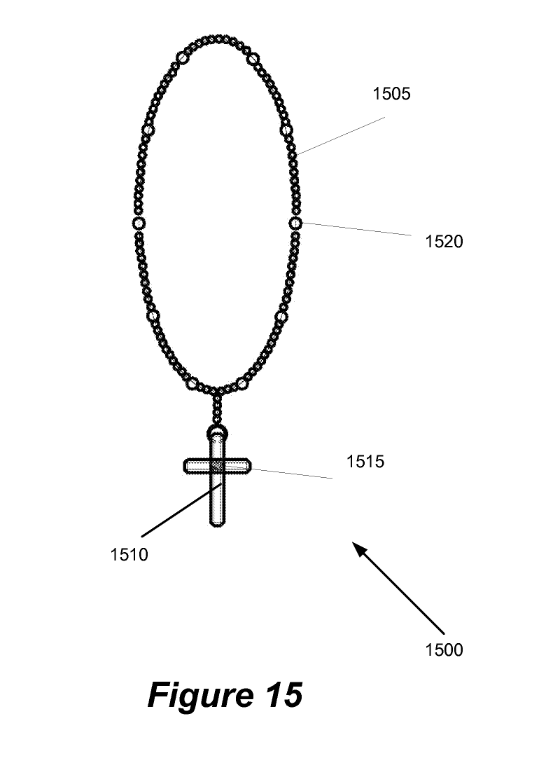

Examples of several objects made according to different embodiments of the invention are given in FIGS. 13 (a goblet), 14 (a candleholder), 15-16 (a piece of jewelry), 17-18 (a box), 19 (a bookmark), and 20 a crucifix. A person or ordinary skill in the art would realize that the disclosed processes and techniques can be used to include soil from predetermined places in other objects.

FIG. 13 illustrates a goblet 1300 (also referred to as a glass, cup, mug, chalice, etc.) in some embodiments. As shown, the goblet includes a bowl (or container portion) 1315, a stem (or center portion) 1305, and a base (or bottom portion) 1310. In some embodiments, the bowl 1315, stem 1305, and base 1310 are separate components that can be attached together while in other embodiments all three or at least two of the bowl 1315, stem 1305, and base 1310 are manufactured as a unitary object. Different embodiments use different methods to make a soil compartment and include soil in it. In some embodiments, goblet 1300 includes a soil compartment inside its center (or stem) 1305. In these embodiments, the center or stem 1305 is made hollow for receiving the soil. In other embodiments, the goblet 1300 includes a soil compartment in its base 1310. In these embodiments, the base 1310 is made hollow for receiving the soil.

In some embodiments, the goblet is made of glass and the soil compartment is built into the goblet during the manufacturing of the goblet (e.g., while the glass is being melted to make the goblet). Similarly, when the goblet is made of crystal or metal, the soil compartment is made during the manufacturing of the crystal goblet. Different embodiments place the soil compartment in different locations such as the base 1310 or the center 1305 of the goblet. In these embodiments, the soil is then placed in the soil compartment and the compartment is sealed during the manufacture process. In different embodiments, the soil compartment includes all or a portion of the base or the center of the goblet.

In some other embodiments, the goblet is manufactured with a soil compartment (e.g., in the center) with a hole for placing soil in the soil compartment. In these embodiments, the soil is added at a time after the manufacturing is completed. In some of these embodiments, the hole is made between the base 1310 and the center 1305 of the goblet. After the soil is added to the center through the hole, the base is screwed, glued, or is otherwise secured to the center. Yet in some other embodiments, the hole is placed between the center 1305 and the container portion (or bowl) 1315 of the goblet. After the soil is added to the center through the hole, the center 1305 is screwed, glued, or is otherwise secured to the container portion 1315. After the soil is placed in the soil compartment, some embodiments permanently seal the soil compartment to preserve authenticity.

In some embodiments the goblet is made of two or more material. For instance, the container portion 1315 and the center portion 1305 are made of metal and the base 1310 is made of glass. In some of these embodiments, the soil is placed in the base 1310 and the base is glued or screwed to the center 1305.

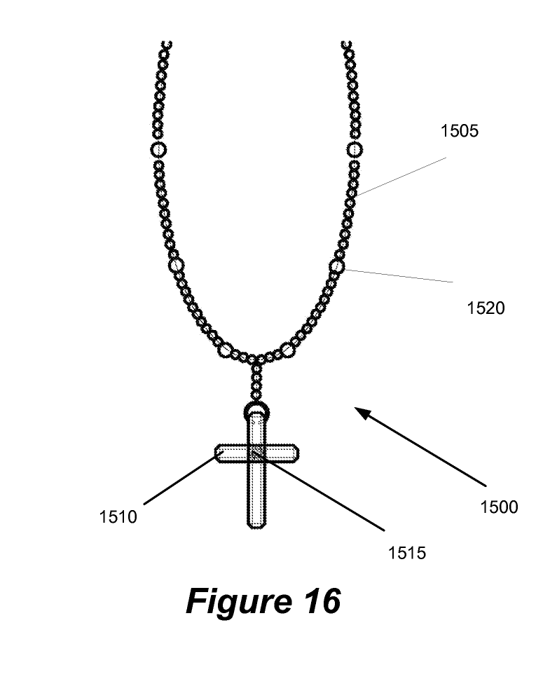

FIG. 14 illustrates a candleholder 1400 for holding a candle 1410 in some embodiments. As shown, the candleholder 1400 includes a body portion 1420, a base 1425, and a soil compartment 1415. The body portion 1420 includes a hollow area 1430 and an opening 1435 for receiving and holding a candle 1410.

In different embodiments, the candleholder is made from different material such as glass, crystal, metal, wood, etc. In some embodiments, the body portion 1420 and the base 1425 are separate components that can be attached together while in other embodiments the body portion 1420 and the base 1425 are manufactured as a unitary object. Similar to the goblet, in some embodiment, the soil compartment in the candleholder is built into the candleholder during the manufacturing of the candleholder (e.g., while the glass is being melted, the wood is being carved, or the metal is being cast or molded). In these embodiments, the soil is placed in the soil compartment and sealed during the manufacture process. Yet in other embodiments, the candleholder 1400 is manufactured with a soil compartment 1415 and a hole, e.g., between the body portion 1420 and the base 1425 of the candleholder. In these embodiments, the soil is added at a time after the manufacturing is completed. The soil is placed in the soil compartment through the hole and the base is screwed, glued, or otherwise secured to the center of the candleholder.

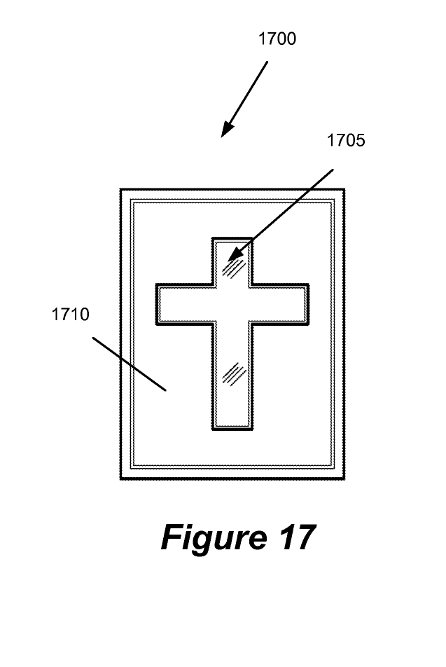

FIG. 15 illustrates a piece of jewelry 1500 according to some embodiments. As shown, this piece of jewelry includes a chain 1505 and a crucifix 1510. Although a crucifix is shown as an example, a person of ordinary skill in the art would realize that other jewelry objects can also be utilized. Also, the jewelry can be made of one or more materials such as glass, crystal, metal, plastic, wood, precious stone, etc. As shown, the crucifix 1510 includes a soil compartment 1515.

FIG. 16 illustrates a close up of the jewelry piece 1500 of FIG. 15. In some embodiments, the soil compartment 1515 for the precious stones is built in the stone when stone is being cut or carved. The soil is then placed in the compartment and the compartment is sealed, preferably by a transparent cover. In some embodiments, the soil compartment for the glass, crystal, metal, or wood is built into the piece of jewelry during the manufacturing of the piece. In these embodiments, the soil is then placed in the soil compartment. The soil compartment is then sealed during the manufacturing process.

Yet in other embodiments, the piece of jewelry is made with a hollow portion as soil compartment and a hole for adding the soil. For instance, in some embodiments, the crucifix 1510 includes in hole through which the soil is placed in the crucifix. This hole is then covered with glass or other preferably transparent material. The cover is then sealed or glued. Similarly, in other embodiments, the compartment is built in a precious stone that is already cut or carved. The soil is then placed in the compartment and the compartment is covered by a transparent material. The cover is then sealed to secure the soil.

In some embodiments, the compartment is made in the chain 1505. For instance, in some embodiments, the chain 1505 includes crystal (or glass beads) 1520 in which the soil compartment is built. The soil is placed in the soil compartment and sealed using one of the methods described above. In some embodiments, the piece of jewelry (e.g., the crucifix) includes a glass, plastic, crystal, or other transparent interior component. The soil is placed in a soil compartment inside the transparent interior and the compartment is sealed with any one of the methods described above. The interior is then covered with an exterior component such as gold, silver, wood, or other attractive material. The exterior component preferably has a window like opening through which the soil stored in the interior component can be seen.

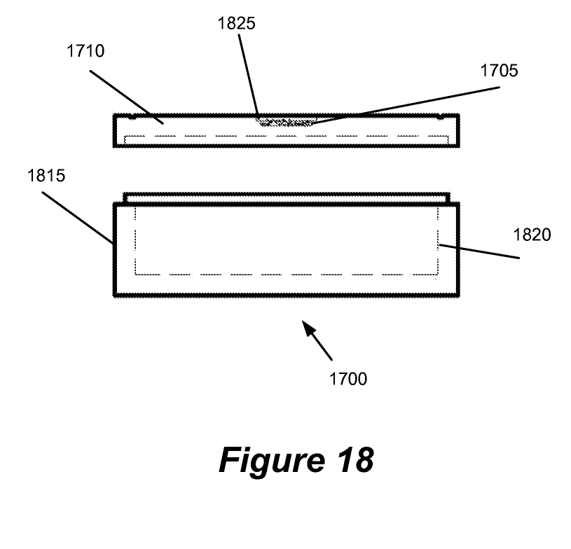

FIG. 17 illustrates a box 1700 of some embodiments. FIG. 18 illustrates the side view of the box 1700. As shown in these figures, the box includes a cover 1710 and a body 1815. The body 1815 includes a hollow portion 1820 for storing different objects. As shown, the box cover 1710 includes a soil compartment 1705 and a soil compartment cover 1825. Other embodiments include the soil compartment on the body 1815.

Different embodiments make the box with different sizes and dimensions. The box in different embodiments can be used to keep books and related objects (e.g., Torah, Keter Torah, Bible, or other religious books), crucifixes, robes, religious objects, jewelry, etc. Although the soil compartment is shown in the shape of a cross, a person of ordinary skill in the art would realize that any other shapes can be readily made for the soil compartment. In some embodiments, the box is made of one or more materials such as wood, metal, glass, crystal, plastic, etc. The soil compartment 1705 is built and sealed after the soil is placed in the soil compartment by using one of the methods and processes described above. For instance, in some embodiment, after the soil is placed in the soil compartment 1705, the soil compartment is covered by a (preferably transparent) cover 1825 made of a material such as glass, crustal, clear plastic, etc. The cover 1825 is then glued or otherwise secured to the box.

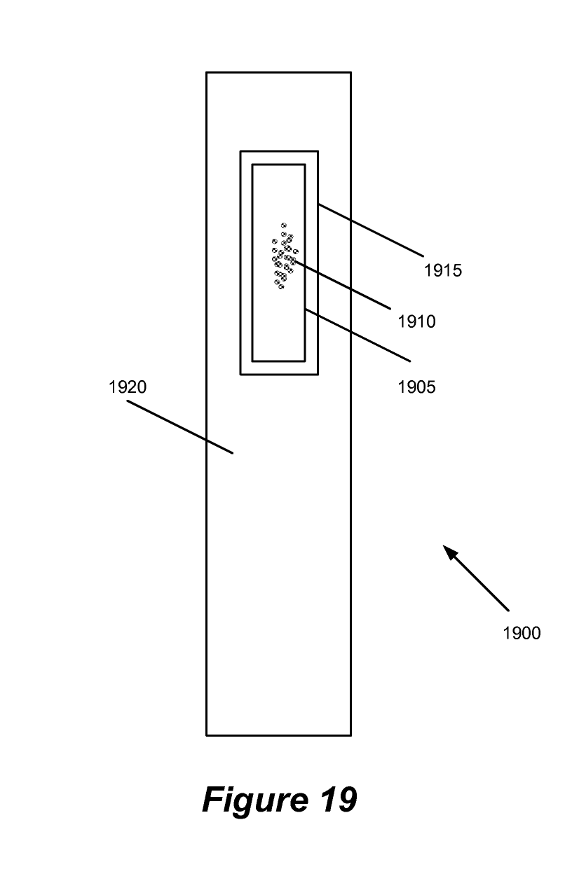

FIG. 19 illustrates a bookmark 1900 in some embodiments. The bookmark can be made of cardboard, glass, plastic, metal, or any material used to make the bookmarks in the art. As shown, the bookmark 1900 includes a soil compartment 1905 for receiving the soil 1910. The soil compartment 1905 is covered by a preferably transparent covering 1915. The covering 1915 is glued or otherwise secured to the body 1920 of the bookmark 1900 by any of the techniques described above.

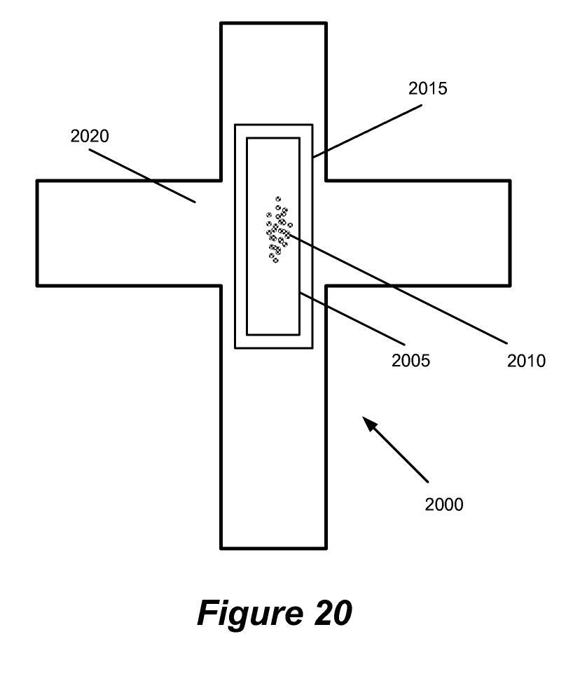

FIG. 20 illustrates a crucifix 2000 in some embodiments. The crucifix can be made of wood, cardboard, glass, plastic, metal, or any material used in the art to make a crucifix. As shown, the crucifix 2000 includes a soil compartment 2005 for receiving the soil 2010. The soil compartment 2005 is covered by a preferably transparent covering 2015. The covering 2015 is glued or otherwise secured to the body 2020 of the crucifix 2000 by any of the techniques described above.

The embodiments described above were just given as examples. A person of ordinary skill in the art would be able to use the disclosed methods and techniques to include or embed soil from predetermined places in other objects. For instances, objects made of wood, metal (e.g., gold, silver, pewter, brass, nickel, etc.), or precious stones (e.g., ruby, emerald, etc.) can include a compartment for receiving the soil. After the soil is placed in the compartment, the compartment is covered by a preferably transparent cover. The cover is then glued or otherwise secured to the object.

Objects made of glass, crystal, plastic, etc., can receive the soil in a soil compartment during the manufacturing process. After the soil is placed in the object, the object is sealed with similar manufacturing techniques. On the other hand, the glass, crystal, plastic, or other objects can be manufactured with a soil compartment and a hole (or opening) through which the soil is included in the soil compartment. At a time after the completion of manufacturing process, the soil is placed in the soil compartment through the hole or opening. After the soil is placed in the compartment, the compartment is sealed by gluing, fastening, or otherwise securing a preferably transparent cover to the compartment. Alternatively, the soil compartment can be sealed by screwing, gluing, or otherwise connecting another component of the object (e.g., the base of a goblet) to the component that includes the soil compartment (e.g., the center or stem of a goblet). In some other embodiments, the compartment covering is hinged, screwed, or otherwise secured by similar methods to the soil compartment.

In some embodiments, the objects used in the described processes are especially made for the purpose of placing the soil in them. Alternatively, the object can be any off-the-shelf (e.g., a wooden box) acquired for the purpose of placing the soil in it.

While the invention has been described with reference to numerous specific details, one of ordinary skill in the art will recognize that the invention can be embodied in other specific forms without departing from the spirit of the invention. In other places, various changes may be made, and equivalents may be substituted for elements described without departing from the true scope of the present invention. For instance, different operations of processes 100 and 900 can be performed in different orders (e.g., the soil can be received after the book cover with the soil compartment is made). Also, the objects can be made of material other than the material given in the examples without deviating from the teachings of the invention. Also, some or all components of each object described in FIGS. 3-8 and 10-20 are either separate components that can be attached together or are manufactured as a unitary object.

Thus, one of ordinary skill in the art would understand that the invention is not limited by the foregoing illustrative details, but rather is to be defined by the appended claims.

What claimed is:

1. A method for making a book, the method comprising:
receiving soil from a predetermined location;
specifying a compartment on the book for storing the soil;
placing the soil in the compartment; and
covering the compartment to secure the soil.

2. The method of claim 1, further comprising certifying the authenticity of the soil to be taken from said predetermined place.

3. The method of claim 1, further comprising certifying said placement of the soil in the compartment.

4. The method of claim 1, wherein the book comprises a cover, wherein the compartment is located on the cover of the book.

5. The method of claim 4, wherein the compartment is located on one of the front outside cover, back outside cover, front inside cover, and back inside cover of the book.

6. The method of claim 1, wherein specifying the compartment comprises identifying an existing cavity on the book.

7. The method of claim 1, wherein specifying the compartment comprises making a cavity on the book.

8. The method of claim 1, wherein covering the compartment comprises covering the compartment with a transparent material.

9. An apparatus comprising:
a book cover comprising a compartment;
a quantity of soil placed inside said compartment, the soil from at least one predetermined place; and
a body attached to the book cover, the body comprising one or more pages.

10. The apparatus of claim 9, wherein the compartment is sealed for holding the soil inside the compartment.

11. The apparatus of claim 9 further comprising a compartment cover for sealing the soil inside the compartment.

12. The apparatus of claim 11, wherein the book cover comprises a groove for holding the compartment cover.

13. The method of claim 11, wherein the compartment cover is glued to the book cover.

14. The apparatus of claim 11, wherein the compartment cover is comprised of a transparent material.

15. The apparatus of claim 11, wherein the compartment cover is comprised of a non-transparent material.

16. The apparatus of claim 11, wherein the compartment cover is comprised of one of glass, crystal, and plastic.

17. The apparatus of claim 9, wherein the book cover is comprised of one of wood, plastic, metal, leather, cardboard, pressboard, cloth, and plastic.

18. The apparatus of claim 9, wherein the soil is certified to be from said predetermined place.
